(19) United States
(12) Patent Application Publication
(10) Pub. No.: US 2021/0354239 A1
(43) Pub. Date: Nov. 18, 2021

(54) LASER PROCESSING APPARATUS

(71) Applicant: DISCO CORPORATION, Tokyo (JP)

(72) Inventors: Toshio TSUCHIYA, Tokyo (JP); Seiji MIURA, Tokyo (JP)

(21) Appl. No.: 17/235,013

(22) Filed: Apr. 20, 2021

(30) Foreign Application Priority Data
May 12, 2020 (JP) 2020-084004

(51) Int. Cl. B23K 26/06; B23K 26/073

(52) U.S. Cl. CPC B23K 26/0648; B23K 2101/40; B23K 26/073; B23K 26/0665

(57) ABSTRACT

A beam adjusting unit of a laser processing apparatus that adjusts a beam diameter of a laser beam includes a first lens unit and a second lens unit that can move along an optical path of the laser beam and a first movement mechanism and a second movement mechanism that move the first lens unit and the second lens unit, respectively, along the optical path. A control unit includes a storing section that stores the beam diameter of the laser beam and positions of the first lens unit and the second lens unit corresponding to the beam diameter in advance, and causes the first movement mechanism and the second movement mechanism to be actuated to move the first lens unit and the second lens unit to positions corresponding to a predetermined beam diameter.

### BACKGROUND OF THE INVENTION

### Field of the Invention

The present invention relates to a laser processing apparatus.

### Description of the Related Art

As a method for dividing a wafer such as a semiconductor wafer, a method has been proposed in which a wafer is split by using a breaking apparatus along laser-processed grooves formed by executing irradiation with a laser beam along streets formed on the wafer (refer to Japanese Patent Laid-open No. Hei 10-305420).

A laser processing apparatus for executing such laser processing includes a chuck table that holds a workpiece and a laser beam irradiation unit that irradiates the workpiece held by the chuck table with a laser beam. This laser beam irradiation unit includes a laser oscillator that oscillates a laser and a condensing lens that condenses a laser beam emitted from the laser oscillator.

Regarding the laser beam irradiation unit, it is desirable that the laser beam made incident on the condensing lens be a collimated beam having a predetermined beam diameter. However, the laser beam emitted from the laser oscillator has individual difference of each laser oscillator and has a divergence angle. As a countermeasure against this, a laser processing apparatus has been disclosed in which beam adjusting means for adjusting the beam diameter and the divergence angle of a laser beam emitted from a laser oscillator is disposed between the laser oscillator and a condensing lens (refer to Japanese Patent Laid-open No. 2008-168323).

### SUMMARY OF THE INVENTION

However, the conventional beam adjusting means executes adjustment to desired beam diameter and divergence angle after the beam diameter and the divergence angle (parallelism) of the laser beam received by a receiver of a charge coupled device (CCD) or the like are checked. Therefore, the adjustment needs to be executed each time. That is, when change to a different beam diameter in laser processing is desired, adjustment work for the desired beam diameter and divergence angle needs to be executed after the apparatus is stopped. Thus, there is a problem that the productivity lowers.

Thus, an object of the present invention is to provide a laser processing apparatus that can change the beam diameter of a laser beam without stopping the apparatus in laser processing.

In accordance with an aspect of the present invention, there is provided a laser processing apparatus including a chuck table that holds a workpiece, a laser beam irradiation unit that irradiates the workpiece held by the chuck table with a laser beam, input means that inputs a processing condition of the laser beam, and a control unit that controls at least the chuck table, the laser beam irradiation unit, and the input means. The laser beam irradiation unit includes a laser oscillator, a condensing lens that condenses the laser beam emitted from the laser oscillator, and a beam adjusting unit that is disposed between the laser oscillator and the condensing lens and adjusts a beam diameter of the laser beam emitted from the laser oscillator. The beam adjusting unit includes a first lens unit and a second lens unit that are disposed on the optical path of the laser beam emitted from the laser oscillator and are disposed movably along the optical path, and a first movement mechanism and a second movement mechanism that move the first lens unit and the second lens unit, respectively, along the optical path. The control unit includes a storing section that stores the beam diameter of the laser beam and positions of the first lens unit and the second lens unit corresponding to the beam diameter in advance. The control unit causes the first movement mechanism and the second movement mechanism of the beam adjusting unit to be actuated to move the first lens unit and the second lens unit to positions corresponding to a predetermined beam diameter input from the input means.

According to the invention of the present application, the beam diameter of the laser beam can be changed without stopping the apparatus in laser processing.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view illustrating a configuration example of a laser processing apparatus according to an embodiment;

FIG. 2 is a schematic diagram schematically illustrating a configuration of a laser beam irradiation unit of the laser processing apparatus illustrated in FIG. 1;

FIG. 3 is a perspective view illustrating a configuration example of a beam adjusting unit of the laser beam irradiation unit illustrated in FIG. 2;

FIG. 4 is a diagram illustrating a configuration example of a screen displayed on a touch panel of the laser processing apparatus illustrated in FIG. 1;

FIG. 5 is a diagram illustrating another configuration example of the screen displayed on the touch panel of the laser processing apparatus illustrated in FIG. 1;

FIG. 6 is a diagram illustrating still another configuration example of the screen displayed on the touch panel of the laser processing apparatus illustrated in FIG. 1; and

FIG. 7 is a table illustrating one example of processing condition data of the laser processing apparatus illustrated in FIG. 1.

### DETAILED DESCRIPTION OF THE PREFERRED EMBODIMENT

An embodiment of the present invention will be described in detail below with reference to the drawings. The present invention is not limited by contents described in the following embodiment. Furthermore, what can be easily envisaged by those skilled in the art and what are substantially the same are included in constituent elements described below. Moreover, configurations described below can be combined as appropriate. In addition, various kinds of omission, replacement, or change of a configuration can be executed without departing from the gist of the present invention.

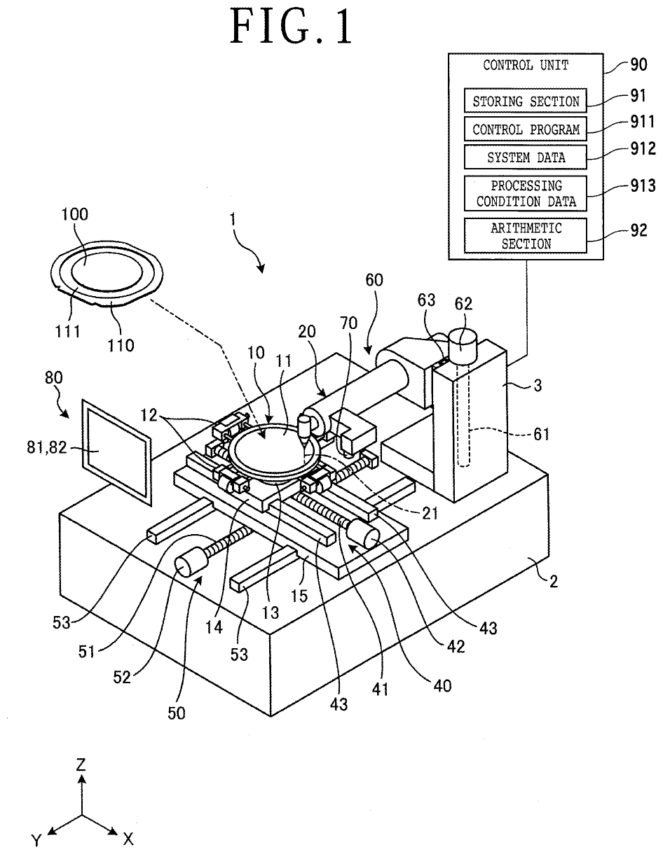

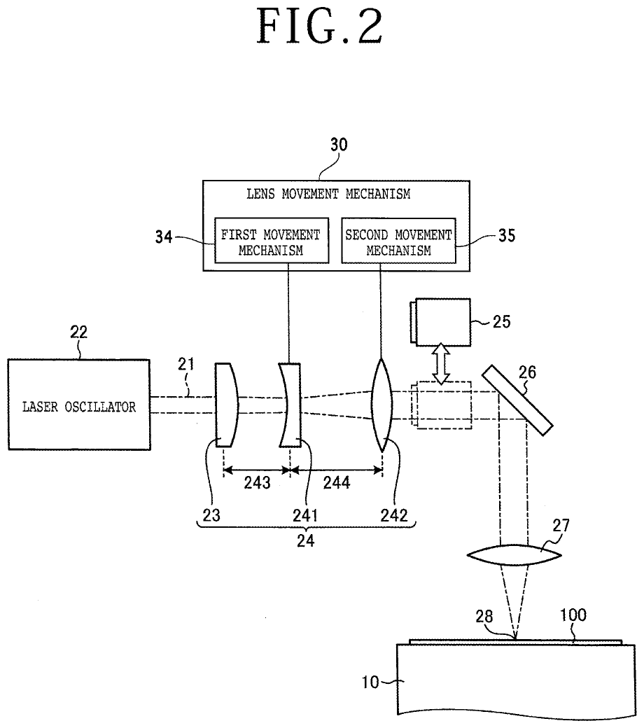

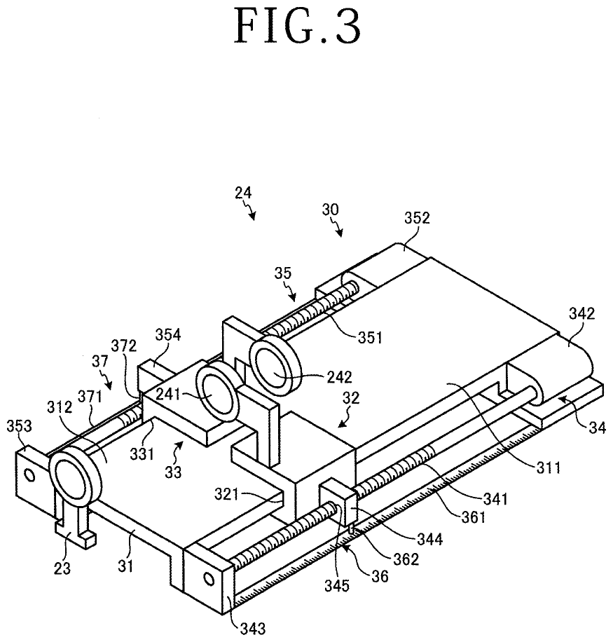

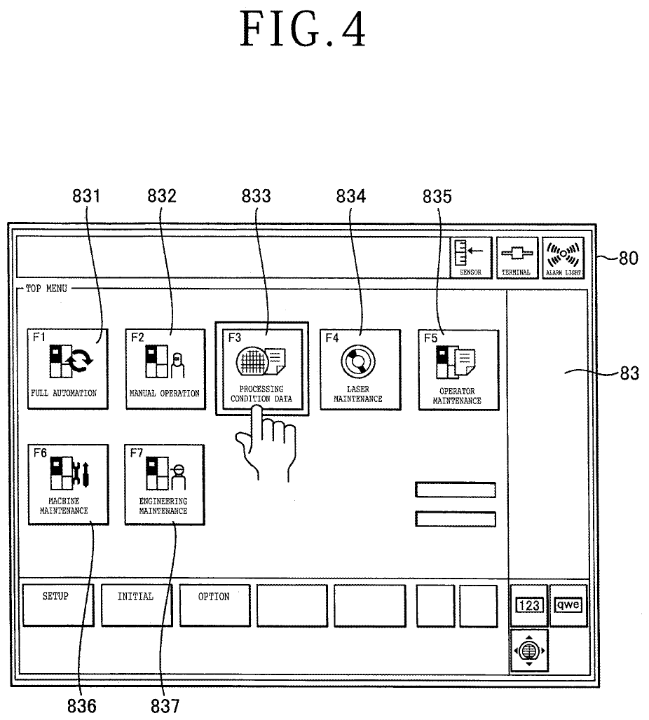

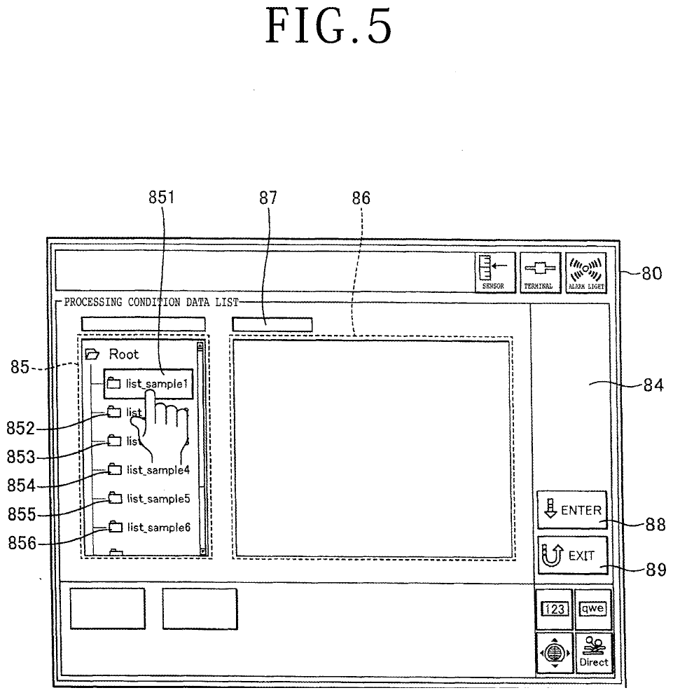

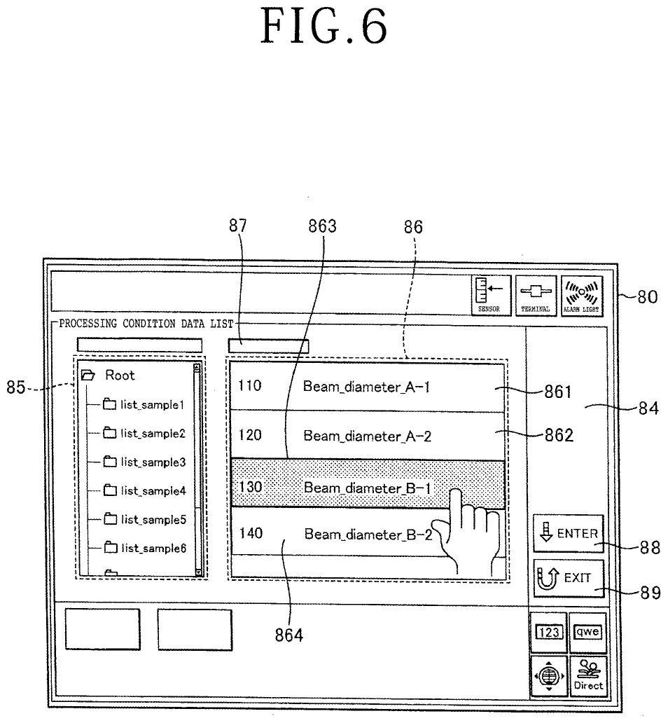

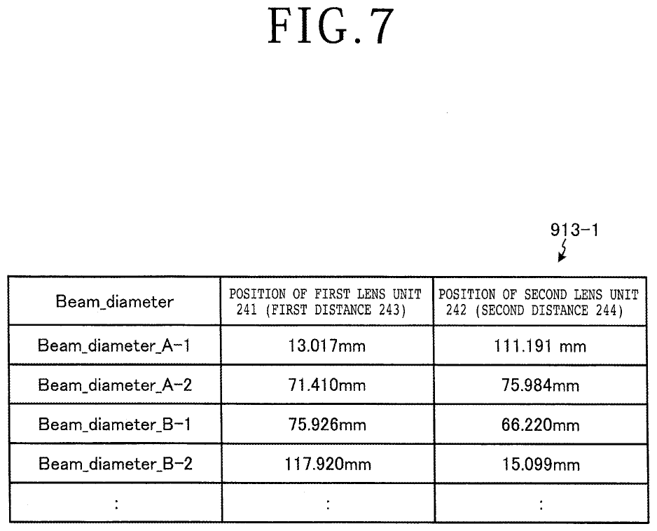

A laser processing apparatus 1 according to the embodiment of the present invention will be described based on the drawings. FIG. 1 is a perspective view illustrating a configuration example of the laser processing apparatus 1 according to the embodiment. FIG. 2 is a schematic diagram schematically illustrating a configuration of a laser beam irradiation unit 20 of the laser processing apparatus 1 illustrated in FIG. 1. FIG. 3 is a perspective view illustrating a configuration example of a beam adjusting unit 24 of the laser beam irradiation unit 20 illustrated in FIG. 2. FIG. 4, FIG. 5, and FIG. 6 are diagrams illustrating configuration examples of a screen displayed on a touch panel 80 of the laser processing apparatus 1 illustrated in FIG. 1. FIG. 7 is a table illustrating one example of processing condition data 913-1 of the laser processing apparatus 1 illustrated in FIG. 1. The laser processing apparatus 1 according to the embodiment is an apparatus that irradiates a workpiece 100 that is a processing target with a laser beam 21 to thereby process the workpiece 100.

As illustrated in FIG. 1, the laser processing apparatus 1 includes a chuck table 10, the laser beam irradiation unit 20, an X-axis direction movement unit 40, a Y-axis direction movement unit 50, a Z-axis direction movement unit 60, an imaging unit 70, the touch panel 80, and a control unit 90. In the following description, an X-axis direction is one direction in a horizontal plane. A Y-axis direction is a direction orthogonal to the X-axis direction in the horizontal plane. A Z-axis direction is a direction orthogonal to the X-axis direction and the Y-axis direction. In the laser processing apparatus 1 of the embodiment, a processing feed direction is the X-axis direction, and an indexing feed direction is the Y-axis direction, and a focal point position adjustment direction is the Z-axis direction.

The workpiece 100 is a wafer such as a semiconductor wafer or an optical device wafer that contains silicon (Si), sapphire (Al₂O₃), gallium arsenide (GaAs), silicon carbide (SiC), or the like as a substrate and has a circular plate shape. The workpiece 100 is not limited to the embodiment and does not need to have the circular plate shape in the present invention. For example, processing of the workpiece 100 by the laser processing apparatus 1 includes modified layer forming processing in which a modified layer is formed inside the workpiece 100 by stealth dicing, groove processing in which a groove is formed in a surface of the workpiece 100, cutting processing in which the workpiece 100 is cut along a planned dividing line, and the like.

The chuck table 10 holds the workpiece 100 by a holding surface 11. For example, the workpiece 100 is placed on the holding surface 11 of the chuck table 10 in a state in which a tape 111 to which an annular frame 110 is stuck and that has a diameter larger than an outer diameter of the workpiece 100 is stuck to a back surface of the workpiece 100 and the workpiece 100 is supported in an opening of the annular frame 110.

The holding surface 11 is formed of porous ceramic or the like and has a circular disc shape. In the embodiment, the holding surface 11 is a flat surface parallel to the horizontal direction. The holding surface 11 is connected to a vacuum suction source through a vacuum suction path, for example. The chuck table 10 sucks and holds the workpiece 100 placed on the holding surface 11. Plural clamp parts 12 that clamp the annular frame 110 that supports the workpiece 100 are disposed around the chuck table 10.

The chuck table 10 is rotated around an axial center parallel to the Z-axis direction by a rotation unit 13. The rotation unit 13 is supported by an X-axis direction moving plate 14. The rotation unit 13 and the chuck table 10 are moved in the X-axis direction by the X-axis direction movement unit 40 through the X-axis direction moving plate 14. The rotation unit 13 and the chuck table 10 are moved in the Y-axis direction by the Y-axis direction movement unit 50 through the X-axis direction moving plate 14, the X-axis direction movement unit 40, and a Y-axis direction moving plate 15.

The laser beam irradiation unit 20 is a unit that irradiates the workpiece 100 held by the chuck table 10 with the pulsed laser beam 21. As illustrated in FIG. 2, the laser beam irradiation unit 20 includes a laser oscillator 22, the beam adjusting unit 24, a beam measuring unit 25, a mirror 26, and a condensing lens 27. At least the condensing lens 27 in the laser beam irradiation unit 20 is supported by the Z-axis direction movement unit 60 installed on a column 3 disposed upright from an apparatus main body 2 of the laser processing apparatus 1 illustrated in FIG. 1.

The laser oscillator 22 emits the laser beam 21 having a predetermined wavelength for processing the workpiece 100. The laser beam 21 emitted by the laser beam irradiation unit 20 has a wavelength having transmissibility or absorbability with respect to the workpiece 100.

The beam adjusting unit 24 adjusts a beam diameter of the laser beam 21 emitted from the laser oscillator 22. In the embodiment, the beam adjusting unit 24 is disposed between the laser oscillator 22 and the beam measuring unit 25. However, in the present invention, the beam adjusting unit 24 may be disposed at any place as long as the place is between the laser oscillator 22 and the condensing lens 27. The beam adjusting unit 24 includes a reference lens 23, a first lens unit 241, a second lens unit 242, and a lens movement mechanism 30.

The reference lens 23 is disposed between the laser oscillator 22 and the first lens unit 241 on an optical path of the laser beam 21 emitted from the laser oscillator 22. The reference lens 23 is a plano-convex lens in the embodiment, but is not limited thereto in the present invention. The reference lens 23 is a lens that serves as a basis of positions of the first lens unit 241 and the second lens unit 242 that can move based on control by the control unit 90 to be described later and does not move based on control by the control unit 90.

The first lens unit 241 is disposed on the optical path of the laser beam 21 emitted from the laser oscillator 22 movably along the optical path. In the embodiment, the first lens unit 241 is a plano-concave lens disposed between the reference lens 23 and the second lens unit 242. The lens included in the first lens unit 241 is one lens in the embodiment. However, the first lens unit 241 may be configured by a group of plural lenses in the present invention. The first lens unit 241 is disposed at a position at a first distance 243 from the reference lens 23 along an optical axis. The first distance 243 can be adjusted through moving the first lens unit 241 along the optical path by a first movement mechanism 34 of the lens movement mechanism 30 to be described later.

The second lens unit 242 is disposed on the optical path of the laser beam 21 emitted from the laser oscillator 22 movably along the optical path. In the embodiment, the second lens unit 242 is a biconvex lens disposed between the first lens unit 241 and the beam measuring unit 25. The lens included in the second lens unit 242 is one lens in the embodiment. However, the second lens unit 242 may be configured by a group of plural lenses in the present invention. The second lens unit 242 is disposed at a position at a second distance 244 from the first lens unit 241 along the optical path. The second distance 244 can be adjusted through moving the second lens unit 242 along the optical path by a second movement mechanism 35 of the lens movement mechanism 30 to be described later.

The beam adjusting unit 24 can adjust the beam diameter of the laser beam 21 emitted from the laser oscillator 22 by adjusting the first distance 243 and the second distance 244 of the first lens unit 241 and the second lens unit 242. At this time, the beam adjusting unit 24 can adjust the laser beam 21 that is emitted from the laser oscillator 22 and has a divergence angle to the laser beam 21 that is collimated.

The lens movement mechanism 30 moves each of the first lens unit 241 and the second lens unit 242 along the optical path of the laser beam 21. As illustrated in FIG. 3, the lens movement mechanism 30 includes a support base 31, a first lens support component 32, a second lens support component 33, the first movement mechanism 34, the second movement mechanism 35, first lens position detecting means 36, and second lens position detecting means 37.

The support base 31 includes a first guide rail 311 and a second guide rail 312. In the first guide rail 311 and the second guide rail 312, lateral sides of both sides are disposed in parallel to each other and in parallel to the optical path of the laser beam 21.

The first lens support component 32 is disposed movably along the first guide rail 311 of the support base 31. The first lens support component 32 includes a first guided rail 321. The first guided rail 321 is fitted to the first guide rail 311 of the support base 31. The first lens support component 32 can move in a direction parallel to the optical path of the laser beam 21 through movement of the first guided rail 321 along the first guide rail 311. The first lens support component 32 supports the first lens unit 241. That is, the first lens unit 241 moves integrally with the first lens support component 32 in the direction parallel to the optical path of the laser beam 21.

The second lens support component 33 is disposed movably along the second guide rail 312 of the support base 31. The second lens support component 33 includes a second guided rail 331. The second guided rail 331 is fitted to the second guide rail 312 of the support base 31. The second lens support component 33 can move in the direction parallel to the optical path of the laser beam 21 through movement of the second guided rail 331 along the second guide rail 312. The second lens support component 33 supports the second lens unit 242. That is, the second lens unit 242 moves integrally with the second lens support component 33 in the direction parallel to the optical path of the laser beam 21.

The first movement mechanism 34 moves the first lens unit 241 along the optical path of the laser beam 21 by moving the first lens support component 32 along the first guide rail 311 of the support base 31. The first movement mechanism 34 includes a male screw rod 341, a pulse motor 342, a bearing block 343, a female screw block 344, and a penetration female screw hole 345.

The male screw rod 341 is disposed in parallel to the first guide rail 311 of the support base 31. The male screw rod 341 is disposed rotatably around an axis. The pulse motor 342 is disposed to be fixed to the support base 31 on one end part side of the male screw rod 341. The pulse motor 342 is a drive source for rotationally driving the male screw rod 341. An output shaft of the pulse motor 342 is joined to the male screw rod 341. The pulse motor 342 is controlled by the control unit 90 to be described later. The bearing block 343 is disposed to be fixed to the support base 31 on the other end part side of the male screw rod 341. The bearing block 343 supports the male screw rod 341 rotatably around the axis. The female screw block 344 is disposed to be fixed to the first lens support component 32. The penetration female screw hole 345 is formed in the female screw block 344. The male screw rod 341 is screwed to the penetration female screw hole 345.

The female screw block 344 moves along the male screw rod 341 through driving of the male screw rod 341 for forward rotation or reverse rotation thereof by the pulse motor 342. Due to this, the first lens support component 32 to which the female screw block 344 is fixed moves along the first guide rail 311. Therefore, the first lens unit 241 supported by the first lens support component 32 moves along the optical path of the laser beam 21. That is, the first movement mechanism 34 moves the first lens unit 241 along the optical path of the laser beam 21 through controlling the pulse motor 342 by the control unit 90 to be described later in such a manner that the male screw rod 341 is driven for forward rotation or reverse rotation thereof.

The second movement mechanism 35 moves the second lens unit 242 along the optical path of the laser beam 21 by moving the second lens support component 33 along the second guide rail 312 of the support base 31. The second movement mechanism 35 includes a male screw rod 351, a pulse motor 352, a bearing block 353, a female screw block 354, and a penetration female screw hole (not illustrated).

The male screw rod 351 is disposed in parallel to the second guide rail 312 of the support base 31. The male screw rod 351 is disposed rotatably around an axis. The pulse motor 352 is disposed to be fixed to the support base 31 on one end part side of the male screw rod 351. The pulse motor 352 is a drive source for rotationally driving the male screw rod 351. An output shaft of the pulse motor 352 is joined to the male screw rod 351. The pulse motor 352 is controlled by the control unit 90 to be described later. The bearing block 353 is disposed to be fixed to the support base 31 on the other end part side of the male screw rod 351. The bearing block 353 supports the male screw rod 351 rotatably around the axis. The female screw block 354 is disposed to be fixed to the second lens support component 33. The penetration female screw hole (not illustrated) is formed in the female screw block 354. The male screw rod 351 is screwed to the penetration female screw hole.

The female screw block 354 moves along the male screw rod 351 through driving of the male screw rod 351 for forward rotation or reverse rotation thereof by the pulse motor 352. Due to this, the second lens support component 33 to which the female screw block 354 is fixed moves along the second guide rail 312. Therefore, the second lens unit 242 supported by the second lens support component 33 moves along the optical path of the laser beam 21. That is, the second movement mechanism 35 moves the second lens unit 242 along the optical path of the laser beam 21 through controlling the pulse motor 352 by the control unit 90 to be described later in such a manner that the male screw rod 351 is driven for forward rotation or reverse rotation thereof.

The first lens position detecting means 36 detects the movement position of the first lens unit 241. The first lens position detecting means 36 includes a linear scale 361 and a reading head 362.

The linear scale 361 is disposed in parallel to the male screw rod 341 of the first movement mechanism 34. The reading head 362 is disposed on the female screw block 344 fixed to the first lens support component 32. The reading head 362 moves along the linear scale 361. The reading head 362 detects the movement position of the first lens unit 241 corresponding to the linear scale 361. The reading head 362 sends out a detection signal to the control unit 90 to be described later.

The second lens position detecting means 37 detects the movement position of the second lens unit 242. The second lens position detecting means 37 includes a linear scale 371 and a reading head 372.

The linear scale 371 is disposed in parallel to the male screw rod 351 of the second movement mechanism 35. The reading head 372 is disposed on the female screw block 354 fixed to the second lens support component 33. The reading head 372 moves along the linear scale 371. The reading head 372 detects the movement position of the second lens unit 242 corresponding to the linear scale 371. The reading head 372 sends out a detection signal to the control unit 90 to be described later.

The detecting means that detect the movement positions of the first lens unit 241 and the second lens unit 242 are not limited to the embodiment. In the present invention, for example, the movement positions may be calculated based on count values of driving pulses that drive the pulse motor 342 of the first movement mechanism 34 and the pulse motor 352 of the second movement mechanism 35.

The beam measuring unit 25 illustrated in FIG. 2 measures the beam diameter of the laser beam 21 for which the beam diameter has been adjusted by the beam adjusting unit 24. The beam measuring unit 25 is disposed movably to a position at which the beam measuring unit 25 receives the laser beam 21 for which the beam diameter has been adjusted by the beam adjusting unit 24. In the embodiment, the beam measuring unit 25 is disposed at a subsequent stage of the beam adjusting unit 24. For example, the beam measuring unit 25 includes a beam profiler that measures the beam diameter and spatial intensity distribution of the laser beam 21. For example, the beam profiler images the laser beam 21 and acquires a planar image of the laser beam 21 that indicates a shape and the spatial intensity distribution of the laser beam 21. The position at which the beam diameter of the laser beam 21 is measured by the beam measuring unit 25 is not limited to the embodiment. In the present invention, the position may be a focal point on which the laser beam 21 is focused by the condensing lens 27, a position at which the laser beam 21 diverges after passing through the focal point, or the like.

The mirror 26 reflects the laser beam 21 toward the workpiece 100 held on the holding surface 11 of the chuck table 10. In the embodiment, the mirror 26 reflects the laser beam 21 for which the beam diameter has been adjusted by the beam adjusting unit 24 toward the condensing lens 27.

The condensing lens 27 focuses the laser beam 21 emitted from the laser oscillator 22 on the workpiece 100 held by the holding surface 11 of the chuck table 10 to cause irradiation thereof. The condensing lens 27 focuses the laser beam 21 reflected by the mirror 26 on a processing point 28.

In the embodiment, the processing point 28 that is the focal point of the laser beam 21 is set on the front surface of the workpiece 100. By executing processing feed of the chuck table 10 while irradiating the processing point 28 with the laser beam 21, a laser-processed groove along a planned dividing line is formed in the front surface of the workpiece 100.

The X-axis direction movement unit 40 illustrated in FIG. 1 is a unit that moves the chuck table 10 and the laser beam irradiation unit 20 relatively in the X-axis direction, which is the processing feed direction. In the embodiment, the X-axis direction movement unit 40 moves the chuck table 10 in the X-axis direction. In the embodiment, the X-axis direction movement unit 40 is installed over the apparatus main body 2 of the laser processing apparatus 1. The X-axis direction movement unit 40 supports the X-axis direction moving plate 14 movably in the X-axis direction.

The X-axis direction movement unit 40 includes a well-known ball screw 41, a well-known pulse motor 42, and well-known guide rails 43. The ball screw 41 is disposed rotatably around an axial center. The pulse motor 42 rotates the ball screw 41 around the axial center. The guide rails 43 support the X-axis direction moving plate 14 movably in the X-axis direction. The guide rails 43 are disposed to be fixed to the Y-axis direction moving plate 15.

The Y-axis direction movement unit 50 is a unit that moves the chuck table 10 and the laser beam irradiation unit 20 relatively in the Y-axis direction, which is the indexing feed direction. In the embodiment, the Y-axis direction movement unit 50 moves the chuck table 10 in the Y-axis direction. In the embodiment, the Y-axis direction movement unit 50 is installed on the apparatus main body 2 of the laser processing apparatus 1. The Y-axis direction movement unit 50 supports the Y-axis direction moving plate 15 movably in the Y-axis direction.

The Y-axis direction movement unit 50 includes a well-known ball screw 51, a well-known pulse motor 52, and well-known guide rails 53. The ball screw 51 is disposed rotatably around an axial center. The pulse motor 52 rotates the ball screw 51 around the axial center. The guide rails 53 support the Y-axis direction moving plate 15 movably in the Y-axis direction. The guide rails 53 are disposed to be fixed to the apparatus main body 2.

The Z-axis direction movement unit 60 is a unit that moves the chuck table 10 and the laser beam irradiation unit 20 relatively in the Z-axis direction, which is the focal point position adjustment direction. In the embodiment, the Z-axis direction movement unit 60 moves the laser beam irradiation unit 20 in the Z-axis direction. In the embodiment, the Z-axis direction movement unit 60 is installed on the column 3 disposed upright from the apparatus main body 2 of the laser processing apparatus 1. The Z-axis direction movement unit 60 supports at least the condensing lens 27 (see FIG. 2) in the laser beam irradiation unit 20 movably in the Z-axis direction.

The Z-axis direction movement unit 60 includes a well-known ball screw 61, a well-known pulse motor 62, and well-known guide rails 63. The ball screw 61 is disposed rotatably around an axial center. The pulse motor 62 rotates the ball screw 61 around the axial center. The guide rails 63 support the laser beam irradiation unit 20 movably in the Z-axis direction. The guide rails 63 are disposed to be fixed to the column 3.

The imaging unit 70 images the workpiece 100 held by the chuck table 10. The imaging unit 70 includes a CCD camera or infrared camera that images the workpiece 100 held by the chuck table 10. For example, the imaging unit 70 is fixed to be adjacent to the condensing lens 27 (see FIG. 2) of the laser beam irradiation unit 20. The imaging unit 70 images the workpiece 100 to obtain an image for performing alignment in which position adjustment between the workpiece 100 and the laser beam irradiation unit 20 is executed, and outputs the obtained image to the control unit 90 to be described later.

The touch panel 80 is installed on the laser processing apparatus 1 in a state in which a display surface is oriented outward. Various screens displayed on the touch panel 80 have a screen configuration according to a kind and a version of a program that runs in the laser processing apparatus 1. A setting screen displayed on the touch panel 80 is configured to include setting items corresponding to the apparatus configuration of the laser processing apparatus 1, i.e., parts installed on the laser processing apparatus 1, kinds of the parts, and so forth. The touch panel 80 has a display unit 81 and input means 82.

The display unit 81 is configured by a display device such as a liquid crystal display (LCD), an organic electro-luminescence display (GELD), or an inorganic electro-luminescence display (IELD).

The display unit 81 displays various screens relating to operation of the laser processing apparatus 1 and so forth. The display unit 81 displays various screens on the basis of control by an arithmetic section 92 of the control unit 90 to be described later. For example, various screens include a menu screen 83 illustrated in FIG. 4, a processing condition data list screen 84 illustrated in FIG. 5 and FIG. 6, a setting screen to individually set processing condition data, and so forth.

The input means 82 illustrated in FIG. 1 inputs processing conditions of the laser beam 21 with which the workpiece 100 is irradiated to the laser processing apparatus 1 according to operation by an operator to an operation screen displayed on the display unit 81.

The input means 82 can be configured to include an input device such as a touch screen. When the input means 82 is configured by a touch screen, the input means 82 can detect contact or approach of a finger of an operator, a pen, a stylus pen, or the like. The detection system of the touch screen may be any system such as a capacitive system, a resistive film system, a surface acoustic wave system, an infrared system, and a load detection system.

In the configuration example illustrated in FIG. 4, plural menu buttons 831 to 837 for executing maintenance, operation, setting, and so forth of the laser processing apparatus 1 are displayed on the menu screen 83. The menu button 831 can accept operation for displaying an operation screen relating to full automation. Further, the menu button 832 can accept operation for displaying an operation screen relating to manual operation. Moreover, the menu button 833 can accept operation for displaying the processing condition data list screen 84 illustrated in FIG. 5 and FIG. 6. In addition, the menu button 834 can accept operation for displaying an operation screen relating to laser maintenance. Further, the menu button 835 can accept operation for displaying an operation screen relating to operator maintenance. Moreover, the menu button 836 can accept operation for displaying an operation screen relating to machine maintenance. In addition, the menu button 837 can accept operation for displaying an operation screen relating to engineering maintenance.

The processing condition data list screen 84 illustrated in FIG. 5 and FIG. 6 is displayed on the touch panel 80 when the arithmetic section 92 of the control unit 90 to be described later detects operator's operation of selecting the menu button 833 in the menu screen 83 illustrated in FIG. 4, for example. In the processing condition data list screen 84, a list of processing condition data of the workpiece 100 is displayed. The processing condition data list screen 84 includes a directory display part 85, a list display part 86, a data number display part 87, an ENTER button 88, and an EXIT button 89.

In the directory display part 85, a list of directories in which processing condition data of the workpiece 100 are saved is displayed. In the directory display part 85, as exemplified in images 851 to 856, information on the directories is displayed with predetermined icon images and directory names configured by character strings such as “rist_sample1.” As the directory name, a directory name set by an operator at the time of saving of processing condition data may be displayed.

In the list display part 86, a list of file names of the processing condition data saved in the directory is displayed. For example, when operator's operation of selecting the image 851 from the directory display part 85 is detected as illustrated in FIG. 5, the arithmetic section 92 of the control unit 90 to be described later causes a list of processing condition data saved in the directory whose directory name is “rist_sample1” to be displayed in the list display part 86 as illustrated in FIG. 6. In the following description, explanation will be made based on the assumption that the processing condition data saved in the directory whose directory name is “rist_sample1” include data relating to the beam diameter of the laser beam 21.

In the list display part 86, as exemplified in images 861 to 864, information on the processing condition data is displayed with data numbers configured by numerals such as “110” and file names configured by character strings such as “Beam_diameter_A-1.” As the data number, a unique numeral automatically assigned in the laser processing apparatus 1 at the time of saving of processing condition data may be displayed. As the file name, a file name set by an operator at the time of saving of processing condition data may be displayed. In the example illustrated in FIG. 6, the processing condition data includes data relating to the beam diameter of the laser beam 21.

In the data number display part 87, the data number uniquely assigned to the currently-selected processing condition data is displayed. For example, when operator's operation of selecting the image 863 corresponding to the processing condition data of a beam diameter of “data number: 130” and “file name: Beam_diameter_B-1” is detected as illustrated in FIG. 6, the arithmetic section 92 of the control unit 90 to be described later causes the data number “130” of the currently-selected processing condition data to be displayed in the data number display part 87.

Execution functions of various kinds of operation corresponding to the screen currently displayed on the touch panel 80 are assigned to the ENTER button 88. For example, as one of functions assigned to the ENTER button 88 when the processing condition data list screen 84 is being displayed on the touch panel 80, a function of causing a setting screen of the processing condition data selected in the list display part 86 to be displayed is included. For example, when operation to the ENTER button 88 is detected in a state in which the data number of the processing condition data is displayed in the data number display part 87, the arithmetic section 92 of the control unit 90 to be described later causes the touch panel 80 to display a setting screen of the currently-selected processing condition data (for example, data number: “130” and file name: “Beam_diameter_B-1”).

The setting screen of the processing condition data includes a processing condition data display part in which plural setting items of the processing condition data are individually displayed, for example. The processing condition data display part displays individual processing condition data on the setting screen of the processing condition data through touch of a desired file name displayed in the list display part 86 by the operator. In the setting screen, setting values set by the operator can be input from the input means 82 regarding the respective items displayed in the processing condition data display part. The touch panel 80 can display a user interface such as a software keyboard and so forth on the display unit 81 according to the detection result of the input means 82. For example, when operation to an item of the processing condition data display part of the setting screen is detected, the touch panel 80 can display a pull-down menu, a software keyboard, or the like corresponding to the item.

A function of causing the touch panel 80 to redisplay the menu screen 83 illustrated in FIG. 4 and so forth are assigned to the EXIT button 89. For example, when operation to the EXIT button 89 is detected, the arithmetic section 92 of the control unit 90 to be described later causes the touch panel 80 to redisplay the menu screen 83 illustrated in FIG. 4.

The control unit 90 illustrated in FIG. 1 is a computer including an arithmetic processing device as arithmetic means, a storing device as storing means, and an input-output interface device as communication means. The arithmetic processing device includes a microprocessor such as a central processing unit (CPU), for example. The storing device has a memory such as a read only memory (ROM) or a random access memory (RAM). The arithmetic processing device executes various kinds of arithmetic operation on the basis of a predetermined program stored in the storing device. The arithmetic processing device outputs various control signals to the above-described respective constituent elements through the input-output interface device, according to an arithmetic result, to execute control of the laser processing apparatus 1. The control unit 90 includes a storing section 91 and the arithmetic section 92.

The storing section 91 can store programs and data for implementing various kinds of processing executed by the control unit 90. The storing section 91 stores a control program 911, system data 912, and processing condition data 913.

The control program 911 can provide functions for controlling processing treatment by the laser processing apparatus 1. More specifically, the control program 911 can provide functions for controlling operation of the rotation unit 13, the laser beam irradiation unit 20, the lens movement mechanism 30, the X-axis direction movement unit 40, the Y-axis direction movement unit 50, the Z-axis direction movement unit 60, the imaging unit 70, and the touch panel 80.

The system data 912 is data relating to the system configuration of the laser processing apparatus 1. The system data 912 includes data relating to the screen configuration of various operation screens displayed on the touch panel 80.

The processing condition data 913 is plural pieces of data relating to basic conditions involved in laser processing treatment. The processing condition data 913 is saved in a predetermined directory, for example. The processing condition data 913 includes processing condition data created by an operator in the laser processing apparatus 1 and a duplicate (copy) of processing condition data created in another laser processing apparatus 1.

The processing condition data created by an operator in the laser processing apparatus 1 includes the processing condition data 913-1 set for each of individual laser processing apparatuses 1 corresponding to the machine difference between apparatuses. As exemplified in FIG. 7, the processing condition data 913-1 includes data in which the beam diameter of the laser beam 21 and the positions of the first lens unit 241 and the second lens unit 242 (see FIG. 2 and so forth) corresponding to the beam diameter are associated. In the case of the example illustrated in FIG. 7, the processing condition data 913-1 includes data in which a file name configured by a character string such as “Beam_diameter_A-1” and the position of the first lens unit 241 and the position of the second lens unit 242 for forming the beam diameter corresponding to the file name are associated. The character strings such as “Beam_diameter_A-1” correspond to the file names displayed in the list display part 86. Data numbers configured by numerals such as “110” may be used instead of the character strings such as “Beam_diameter_A-1.” The position of the first lens unit 241 and the position of the second lens unit 242 are represented by the first distance 243 and the second distance 244 (see FIG. 2 and so forth) in the example illustrated in FIG. 7. The processing condition data 913-1 is generated for each of individual laser processing apparatuses 1 at the time of manufacturing of the laser processing apparatuses 1, at the time of factory shipment, or the like, for example. Thus, even in the same kind of laser processing apparatuses 1, the processing condition data 913-1 differs for each of individual laser processing apparatuses 1 in some cases.

Based on the control program 911 stored in the storing section 91, the arithmetic section 92 controls each of the above-described respective constituent elements of the laser processing apparatus 1 and causes the laser processing apparatus 1 to execute processing operation on the workpiece 100. The arithmetic section 92 controls the rotation unit 13, the laser beam irradiation unit 20, the lens movement mechanism 30, the X-axis direction movement unit 40, the Y-axis direction movement unit 50, the Z-axis direction movement unit 60, the imaging unit 70, and the touch panel 80.

For example, the arithmetic section 92 causes the storing section 91 to store the beam diameters of the laser beam 21 and the positions of the first lens unit 241 and the second lens unit 242 (see FIG. 2 and so forth) corresponding to the beam diameters as the processing condition data 913. The arithmetic section 92 causes the imaging unit 70 to image the workpiece 100, for example. The arithmetic section 92 executes image processing of an image obtained by imaging by the imaging unit 70, for example. The arithmetic section 92 detects a processing line of the workpiece 100 by the image processing, for example. For example, the arithmetic section 92 causes the first movement mechanism 34 and the second movement mechanism 35 (see FIG. 2 and so forth) to be actuated to move the first lens unit 241 and the second lens unit 242 to positions corresponding to a predetermined beam diameter specified from the input means 82 of the touch panel 80 to be described later. For example, the arithmetic section 92 causes the X-axis direction movement unit 40 to be driven to cause the processing point 28 that is the focal point of the laser beam 21 to move along the processing line and causes the laser beam irradiation unit 20 to execute irradiation with the laser beam 21.

As described above, in the laser processing apparatus 1 of the embodiment, the storing section 91 of the control unit 90 stores the beam diameters of the laser beam 21 and the positions of the first lens unit 241 and the second lens unit 242 corresponding to the beam diameters in advance. The beam diameters of the laser beam 21 and the positions of the first lens unit 241 and the second lens unit 242 corresponding to the beam diameters, stored by the storing section 91, are set for each of individual laser processing apparatuses 1 corresponding to the machine difference between apparatuses. The beam diameters of the laser beam 21 and the positions of the first lens unit 241 and the second lens unit 242 corresponding to the beam diameters, stored by the storing section 91, may be set regarding each frequency of the laser beam 21 emitted from the laser oscillator 22.

The processing condition data of the beam diameters of the laser beam 21 and the positions of the first lens unit 241 and the second lens unit 242 corresponding to the beam diameters can be generated by measuring the beam diameters of the laser beam 21 with the respective first distances 243 and second distances 244 by the beam measuring unit 25, for example.

In the laser processing apparatus 1 of the embodiment, the control unit 90 causes the first movement mechanism 34 and the second movement mechanism 35 of the beam adjusting unit 24 to be actuated to move the first lens unit 241 and the second lens unit 242 to positions corresponding to a predetermined beam diameter specified from the input means 82. At this time, the control unit 90 moves the first lens unit 241 and the second lens unit 242 on the basis of the processing condition data stored in the storing section 91 in advance. That is, the laser processing apparatus 1 can automatically change the beam diameter of the laser beam 21 to the respective beam diameters specified from the input means 82. Thus, the laser processing apparatus 1 allows adjustment to a desired beam diameter in a short time and has repeatability for the same beam diameter.

Therefore, the laser processing apparatus 1 provides an effect that the beam diameter does not need to be adjusted each time and therefore selection of the laser processing condition when a different device is processed becomes easy. For example, even in the case of processing a wafer different in material, thickness, street size, and so forth depending on the kind, it is easy to execute the processing with change in the beam diameter of the laser beam 21 incident on the condensing lens 27. Furthermore, it is also easy to execute laser processing with combining the laser beam 21 of various beam diameters, such as changing the beam diameter of the first path and the second path.

Moreover, the apparatus does not need to be stopped for adjustment of the beam diameter and adjustment can be automatically executed even in laser processing. Therefore, the time taken for adjustment work can be shortened and the lowering of the productivity can be suppressed. Furthermore, the beam diameters of the laser beam 21 and the positions of the first lens unit 241 and the second lens unit 242 corresponding to the beam diameters are set for each of individual laser processing apparatuses 1, and therefore, the machine difference between apparatuses can be reduced.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A laser processing apparatus comprising:
a chuck table that holds a workpiece;
a laser beam irradiation unit that irradiates the workpiece held by the chuck table with a laser beam;
input means that inputs a processing condition of the laser beam; and
a control unit that controls at least the chuck table, the laser beam irradiation unit, and the input means,
wherein the laser beam irradiation unit includes
a laser oscillator,
a condensing lens that condenses the laser beam emitted from the laser oscillator, and
a beam adjusting unit that is disposed between the laser oscillator and the condensing lens and adjusts a beam diameter of the laser beam emitted from the laser oscillator,
the beam adjusting unit includes
a first lens unit and a second lens unit that are disposed on an optical path of the laser beam emitted from the laser oscillator and are disposed movably along the optical path, and
a first movement mechanism and a second movement mechanism that move the first lens unit and the second lens unit, respectively, along the optical path,
the control unit includes a storing section that stores the beam diameter of the laser beam and positions of the first lens unit and the second lens unit corresponding to the beam diameter in advance, and
the control unit causes the first movement mechanism and the second movement mechanism of the beam adjusting unit to be actuated to move the first lens unit and the second lens unit to positions corresponding to a predetermined beam diameter input from the input means.
